(19) United States
(12) Patent Application Publication
(10) Pub. No.: US 2013/0310236 A1
(43) Pub. Date: Nov. 21, 2013

(54) PRESS MACHINE DIE UNIT REPLACING DEVICE

(71) Applicants: Yoichiro Kojima, Toyota-shi (JP); Masanori Ogawa, Toyota-shi (JP); Masaaki Ando, Toyota-shi (JP); Akira Sakakibara, Toyota-shi (JP)

(72) Inventors: Yoichiro Kojima, Toyota-shi (JP); Masanori Ogawa, Toyota-shi (JP); Masaaki Ando, Toyota-shi (JP); Akira Sakakibara, Toyota-shi (JP)

(73) Assignees: TEKUNOHAMA CO., LTD, Toyota-shi, Aichi (JP); KOJIMA PRESS INDUSTRY CO., LTD., Toyota-shi, Aichi (JP)

(21) Appl. No.: 13/990,645

(22) PCT Filed: Nov. 30, 2010
(86) PCT No.: PCT/JP2010/071387

§ 371 Date: Aug. 8, 2013

(51) Int. Cl. B23Q 3/155; B21D 37/04

(52) U.S. Cl. CPC B23Q 3/15573; B21D 37/04
USPC 483/28; 72/446

(57) ABSTRACT

A press machine die unit replacing device for replacing die units in a press machine may include a die unit storage device controllably rotatably disposed on a position adjacent to a press machine and having various types of replacement die units that are placed thereon, and a transferring mechanism that is capable of transferring the die units between the die unit storage device and the press machine. The die units selected by controllable rotation of the die unit storage device are capable of being carried in or discharged from the press machine via the transferring mechanism.

### TECHNICAL FIELD

The present invention relates to a press machine die unit replacing device for replacing die units in a press machine.

### BACKGROUND ART

Generally, in order to replace die units in a press machine, the die units are transferred between the press machine and a die unit storage space in which many different types of die units are stocked. That is, the die units removed from the press machine are transferred to the die unit storage space. Thereafter, die units for a subsequent use are selected and transferred to the press machine.

Further, a press machine shown in, for example, Patent Document 1 is a multi-tiered press machine in which a plurality of die units are arranged in series in a die closing and opening direction of each of the die units. In such a press machine, the die units in respective tiers can be replaced at the same time.

### PRIOR ART DOCUMENT

### Patent Document

Patent Document 1: Japanese Laid-Open Patent Publication No. 2000-015496

### SUMMARY OF THE INVENTION

### Problems to be Solved by the Invention

As described above, in order to replace the die units in the press machine, the heavy die units are transferred between the die unit storage space and the press machine. This operation may take a lot of time. In particular, when the press machine is used for manufacturing of a wide variety of products in small quantity, a time required for die unit replacement is obstructive to the realization of the purpose. Also, when the press machine is the multi-tiered press machine, the die units in respective tiers must respectively be replaced. Such an operation may take more time.

The present invention has been made in order to solve the problems described above. Accordingly, it is an object of the present invention to make it possible to select and replace many different types of die units at short times in a press machine, and to effectively realize manufacturing of a wide variety of products in small quantity.

### Means for Solving the Problems

The present invention is intended to attain the object described above and is constructed as follows.

A press machine die unit replacing device for replacing die units in a press machine may include a die unit storage device controllably rotatably disposed on a position adjacent to a press machine and having various types of replacement die units that are placed thereon, and a transferring mechanism that is capable of transferring the die units between the die unit storage device and the press machine. The die units selected by controllable rotation of the die unit storage device are capable of being carried in or discharged from the press machine via the transferring mechanism.

Preferably, two die unit storage devices may be disposed adjacent to the press machine. Further, the die units are capable of being carried in the press machine from the respective die unit storage devices via respective transferring mechanisms and capable of being discharged from the press machine via the transferring mechanisms.

More preferably, the press machine comprises a multi-tiered press machine in which a plurality of die units are arranged in series in a die closing and opening direction of each of the die units. Further, the die unit storage device and the transferring mechanisms are positioned so as to correspond to respective tiers of the press machine.

### Effects of the Invention

In the present invention, the die units selected by controllable rotation of the die unit storage device can be carried in or discharged from the press machine. Therefore, in the press machine, various types of replacement die units can be selected and replaced in a short time. As a result, manufacturing of a wide variety of products in small quantity can be effectively realized.

Further, the two die unit storage devices may be disposed adjacent to the press machine, so that carrying-in or discharging of the die units can be performed from two directions in the press machine. Therefore, for example, the die units can be discharged from the press machine in a direction. At the same time, the new die units can be carried in the press machine in another direction. Thus, working time that is required to select and replace various types of replacement die units can be further reduced.

Further, when the die unit storage device and the transferring mechanisms are provided so as to correspond to the multi-tiered press machine, the die units positioned in the respective tiers, the die units positioned in the respective tiers of the press machine can be simultaneously replaced. Therefore, the more die units can be replaced in a short time.

### BRIEF DESCRIPTION OF THE DRAWINGS

FIG. 1 is an elevational view of a press machine die unit replacing device.

FIG. 2 is a plan view of the press machine die unit replacing device.

FIG. 3 is a partially enlarged elevational view of the press machine die unit replacing device.

FIG. 4 is a partially enlarged plan view of the press machine die unit replacing device.

FIG. 5 is a set of elevational views which illustrates a condition in which a press machine is being changed.

FIG. 6 is a plan view of the press machine die unit replacing device which view illustrates a die unit replacement procedure.

### MODE FOR CARRYING OUT THE INVENTION

In the following, a mode for carrying out the present invention will be described with reference to the drawings.

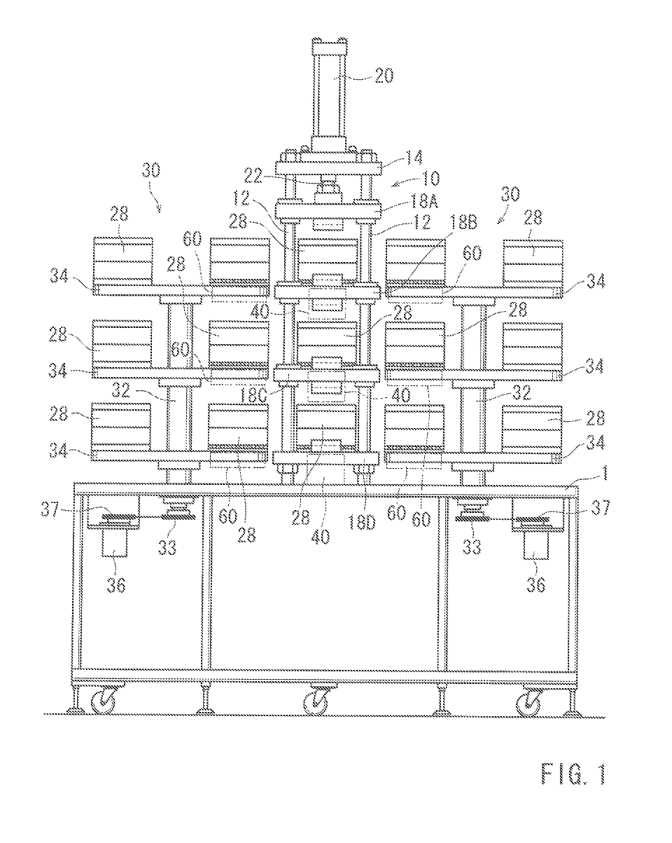

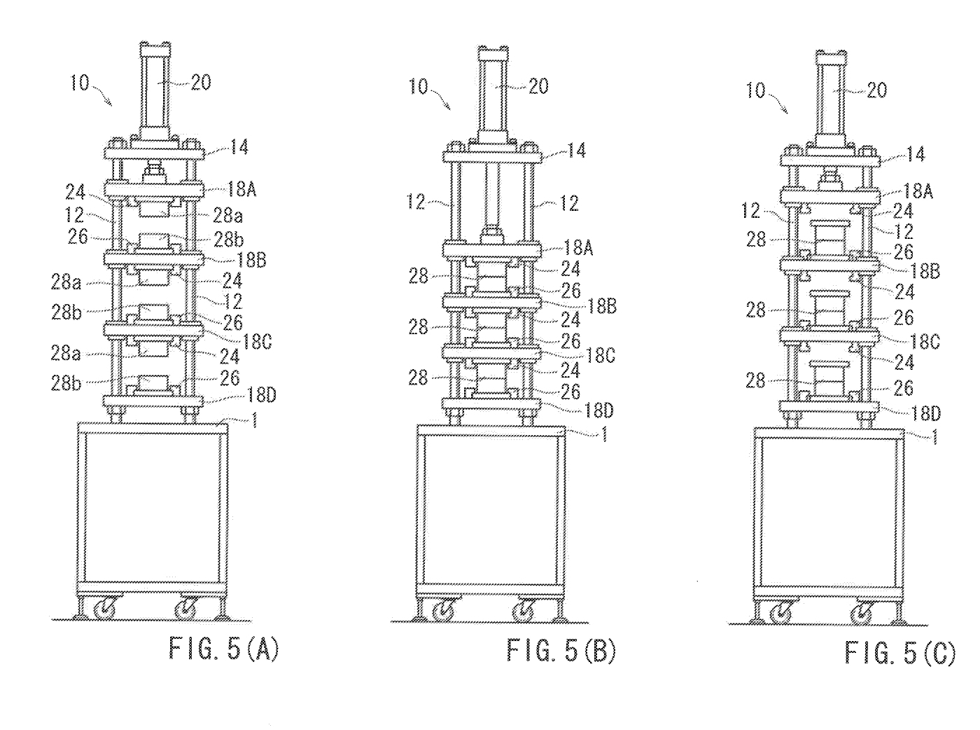

A press machine 10 and two die unit storage devices 30 may be disposed on an upper surface of a base 1 of a press machine die unit replacing device. The die unit storage devices 30 may be adjacently positioned on both sides of the press machine 10. As shown in FIGS. 1 and 5, the press machine 10 is a multi-tiered press machine in which a plurality of (three) die units 28 are arranged in series in a die closing and opening direction (a vertical direction) of each of the die units 28. Further, each of the die unit storage devices 30 may have many different types of replacement die units 28 that are disposed thereon in positions corresponding to respective tiers of the press machine 10. The die units 28 in respective tiers of the press machine 10 can be replaced with the die units 28 stocked in the die unit storage devices 30 by cooperative action of transferring mechanisms T which will be hereinafter described.

The multi-tiered press machine 10 may include four vertically elongated rods 12 positioned, on the base 1 and an upper plate 14 on which a hydraulic cylinder 20 as a drive source for press working is disposed. The upper plate 14 may be secured to upper end portions of the rods 12. Further, four die plates 18 may be positioned between the upper surface of the base 1 and the upper plate 14. The die plates 18 may be attached to the rods 12 so as to be positioned therealong in tiers. Further, in order to describe the die plates 18 indivisually, the die plates 18 will respectively be referred to as die plates 18A, 18B, 18C and 18D starting from above in the drawings. Conversely, in order to describe the die plates 18 collectively, the die plates 18 will be directly used.

The lowermost die plate 18D of the die plates 16 may be secured to the rods 12, and the remaining die plates 18A, 18B and 18C are configured to move up and down along the rods 12. Further, the uppermost die plate 18A may be connected to a plunger 22 of the hydraulic cylinder 20. Thus, the die plate 18A can directly receive a drive force from the hydraulic cylinder 20, so as to move up and down. Conversely, the die plates 18B and 18C are respectively suspended from the die plate 18A via suspension poles (not shown). As shown in FIG. 5(A), even when the press machine 10 is in a die opening condition, the die plates 18 can be spaced at regular intervals.

The three die units 28 of the press machine 10 may respectively be disposed between the die plates 18. As shown in FIGS. 5(A) and (B), upper dies 28a and lower dies 28b of the die units 28 may respectively be clamped by upper die clamps 24 and lower die clamps 26 that are respectively provided to the die plates 18. Therefore, when the hydraulic cylinder 20 is controllably actuated in the die opening condition shown in FIG. 5(A), the die plate 18A can be lowered, so that the die plates 18B and 18C can be lowered in synchrony therewith. As a result, as shown in FIG. 5(B), the die units 28 can respectively be closed. Thus, the press working can be performed in each of the die units 28.

When a die unit replacing operation is performed, which will be hereinafter described, the upper die clamps 24 and the lower die clamps 26 provided to the die plates 18 may be released in a die closing condition shown in FIG. 5(B). Thereafter, the die plates 18A, 18B and 18C are respectively lifted to upper dead points. That is, the press machine 10 is changed to a condition shown in FIG. 1 or FIG. 5(C).

The two die unit storage devices 30 are oppositely positioned across the press machine 10. However, die unit storage devices 30 respectively have the same structure as each other. The die unit storage devices 30 may respectively have vertically elongated rotatable shafts 32. The rotatable shafts 32 may be rotatably supported on the base 1, so as to rotate about axes thereof. Further, three disk-shaped turn tables 34 may be attached to each of the rotatable shafts 32. The turn tables 34 may be positioned so as to be centered on each of the axes of the rotatable shafts 32. The turn tables 34 may be vertically arranged in three tiers along each of the rotatable shafts 32 and may be connected thereto. Further, the turn tables 34 may respectively be positioned so as to correspond to positions of the die plates 18B, 18C and 18D of the press machine 10 in a condition shown in FIG. 1 or FIG. 5(C) in which the die unit replacing operation is performed.

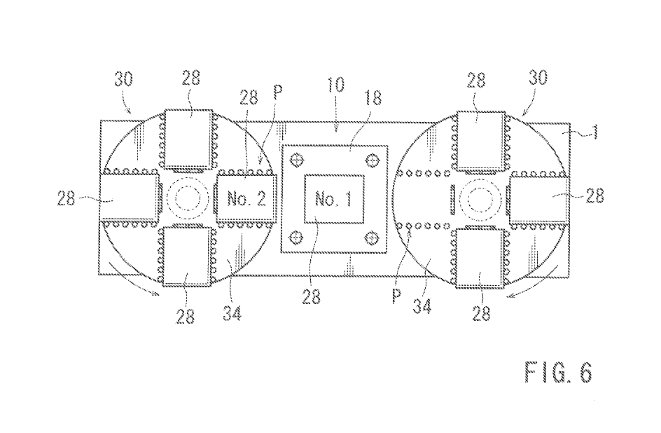

The rotatable shafts 32 may respectively have sprockets 33 that are attached to lower end portions thereof in an interior of the base 1. The sprockets 33 may respectively be configured so as to receive rotative forces from sprockets 37 of motors 36 received in the interior of the base 1 via roller chains or other such devices (FIG. 1). Upon controllable activation of the motors 36, the turn tables 34 of the die unit storage devices 30 can be rotated concurrently about the axes of the rotatable shafts 32. Further, the motors 36 are different from each other in arrangement, so that the die unit storage devices 30 can respectively rotate in opposite rotational directions. For example, as shown by an arrow in FIG. 6, the left die unit storage device 30 can rotate counterclockwise whereas the right die unit storage device 30 can rotate clockwise.

A plurality of (four at the most) die units 28 may circumferentially be placed on each of the turn tables 34 of the die unit storage devices 30 at angular intervals of 90 degrees. The die units 28 can respectively be guided by a plurality of guide rollers 35 disposed on an upper surface of each of the turn tables 34, so as to slidably reciprocate linearly in a radial direction of each of the turn tables 34.

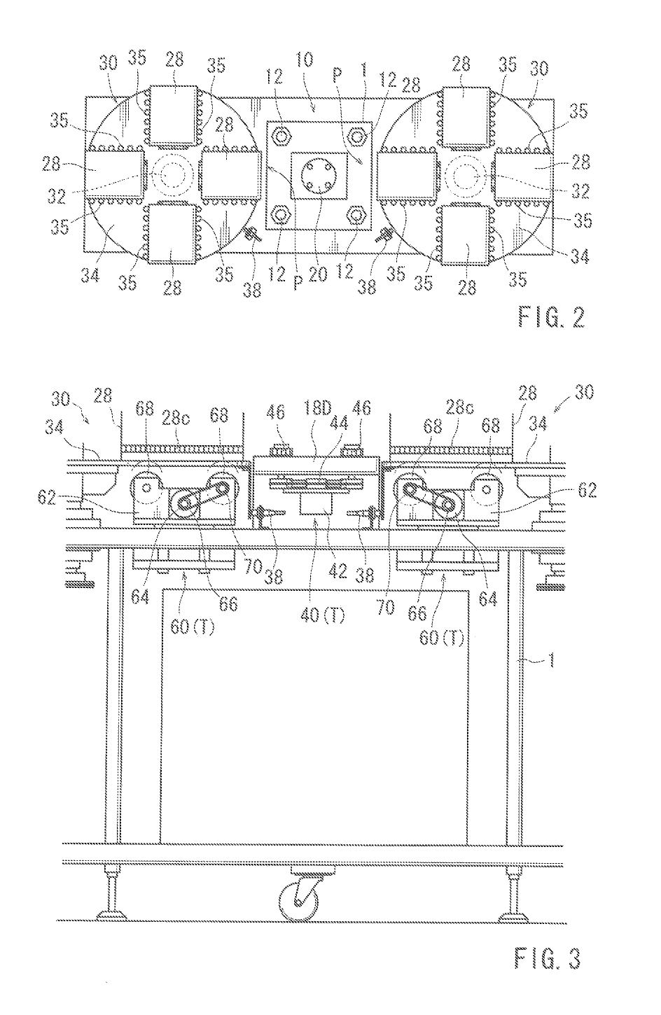

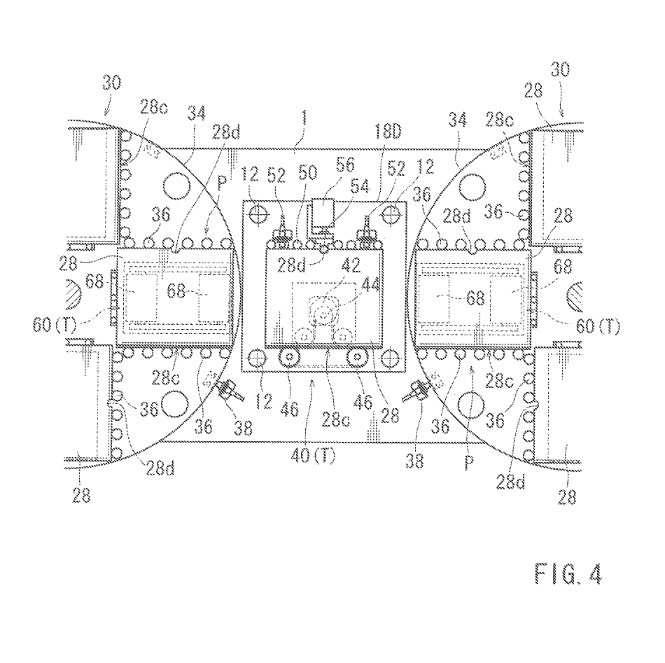

As previously described, upon rotation of the turn tables 34, the die units 28 placed on the turn tables 34 can be selectively shifted to gateway positions P (e.g., FIG. 2 or FIG. 4) that are positioned opposite to the press machine 10. Each of the die units 28 shifted to the gateway positions P can be replaced with each of the die units 28 in the press machine 10. Therefore, the turn tables 34 are configured such that rotation thereof can be detected by position detection sensors 38. Further, the motors 36 may be configured such that activation thereof can be controlled by signals from the position detection sensors 38.

The transferring mechanisms T for transferring the die units 28 between the press machine 10 and the die unit storage devices 30 may respectively be composed of press machine-side transferring units 40 and storage device-side transferring units 60. However, the press machine-side transferring units 40 can be omitted. In such a case, each of the storage device-side transferring units 60 may be modified so as to increase a transferring stroke of each of the die units 28.

The press machine-side transferring units 40 may respectively be provided to the die plates 18B, 18C and 18D of the press machine 10 on which the three die units 28 are respectively placed. A structure of each of the press machine-side transferring units 40 will be described with reference to FIG. 3 and FIG. 4 each of which shows the press machine-side transferring unit 40 provided to the die plate 18D. A motor 42 may be attached to a lower portion of the die plate 18D. Further, a pair of drive pinions 46 may be disposed on an upper surface of the die plate 18D in one side (a lower side in FIG. 4) of the die plate 18D. The drive pinions 46 may be rotatably supported on the die plate 18D and may respectively have pulleys 48. The pulleys 48 may respectively be positioned in the lower portion of the die plate 18D and may respectively be connected to axial ends of the drive pinions 46. The pulleys 48 may respectively be configured so as to receive a rotative force from a pulley 44 of the motor 42 via a timing belt or other such devices (FIG. 4). The drive pinions 46 can respectively mesh with a rack 28c (FIG. 3) formed in one side surface of the lower die 28b of each of the die units 28.

A plurality of guide rollers 50 capable of guiding the die units 28, a pair of position detecting sensors 52 and a positioning pin 54 actuated by an actuator 56 are disposed on the upper surface of the die plate 18D in the other side (an upper side in FIG. 4) of the die plate 18D, so as to be positioned opposite to the drive pinions 46. A position of the die unit 28 on the die plate 18D can be detected by the position detecting sensors 52. The actuator 56 of the positioning pin 54 can be controlled by signals from the position detection sensors 52. Thus, the positioning pin 54 can be engaged with a recessed portion 28d formed in the other side surface of the lower die 28b of each of the die units 28, i.e., in a side surface positioned opposite to the rack 28c. As a result, the die unit 28 on the die plate 18D can be held in a predetermined position.

The storage device-side transferring units 60 may respectively be disposed on the turn tables 34 of the die unit storage devices 30 in lower portions of the gateway positions P. A detailed structure of each of the storage device-side transferring units 60 will be described with reference to FIG. 3 and FIG. 4 each of which shows the storage device-side transferring units 60 corresponding to the turn tables 34 in a lowermost tier. Lifting brackets 62 may respectively be vertically movably supported on base 1-side frames positioned on the lower portions of the gateway positions P. Motors 64 may respectively be attached to the lifting brackets 62. Further, a pair of transferring rollers 68 horizontally positioned may be rotatably supported on each of the lifting brackets 62. A rotative drive force of each of the motors 64 can be transmitted from a pulley 66 of each of the motors 64 to a pulley 70 of one of the transferring rollers 68 via a belt or other such devices.

Each of the turn tables 34 may have openings (not shown) that are formed in each of portions on which the die units 28 are placed. The openings may be configured such that the both transferring rollers 68 of each of the storage device-side transferring units 60 can enter thereinto. Thus, when the lifting bracket 62 of each of the storage device-side transferring units 60 is lifted up, the both transferring rollers 68 can be pressed to each of bottom surfaces of the die units 28 (the lower dies 28b) positioned in the gateway positions P.

Further, with regard to the turn tables 34 in an upper tier and a middle tier, the base 1-side frames may also he positioned on the lower portions of the gateway positions P. Similarly, the lifting brackets 62 of the storage device-side transferring units 60 may respectively be vertically movably supported on the frames.

Next, the die unit replacing operation will be described.

When the press machine 10 is in a die unit replaceable condition shown in FIG. 1 and FIG. 5(C), the die units 28 in respective tiers are respectively slidable on the die plates 18B, 18C and 18D. Further, both of the die unit storage devices 30 can be rotated about the axes of the rotatable shafts 32 due to the activation of the respective motors 36. Upon rotation thereof, for example, in one of the die unit storage devices 30, the die units 28 for replacement on the turn tables 34 can be shifted to the gateway positions P. Conversely, in the other of the die unit storage devices 30, empty spaces of the turn tables 34 on which the die units 28 are not placed can be shifted to the gateway positions P.

Now, as shown in FIG. 6, the die units 28 used in a preceding process in respective tiers of the press machine 10 may respectively be named as “No. 1.” Conversely, the die units 28 for replacement of the left die unit storage device 30 may respectively be named as “No. 2.” First, the drive pinions 46 of the press machine-side transferring units 40 may be rotated, so that the die units 28 named as “No. 1” can respectively be slid toward the empty spaces on the turn tables 34 of the right die unit storage devices 30. After the die units 28 named as “No. 1” are transferred to the empty spaces on the turn tables 34, the lifting brackets 62 of the storage device-side transferring units 60 positioned in the gateway positions P may be lifted up while the motors 64 may be activated, As a result, the transferring rollers 68 can rotate while being pressed to the bottom surface of the die units 28 named as “No. 1,” so that the die units 28 can be continuously slid and can be fitted into the empty spaces on the turn tables 34. Thus, the die units 28 named as “No. 1” can be transferred from the press machine 10 to the die unit storage device 30.

Next, the storage device-side transferring units 60 positioned in the gateway positions P on which the die units 28 named as “No. 2” are positioned may be operated in the same manner as previously described, so that the die units 28 named as “No. 2” can be slid toward the press machine 10. After the die units 28 named as “No. 2” are transferred to the press machine 10, the drive pinions 46 of the press machine-side transferring units 40 may be rotated in the reverse direction of a rotational direction described above, so that the die units 28 can be continuously slid. When each of the die units 28 named as “No. 2” is slid to the predetermined position, the positioning pin 54 can engage the recessed portion 28d formed in each of the lower dies 28b of the die units 28, so that each of the die units 28 can be held in the position. Thus, the die units 28 named as “No. 2” can be transferred from the die unit storage device 30 to the press machine 10.

Thus, in respective tiers of the press machine 10, a replacement of the die units 28 named as “No. 1” with the die units 28 named as “No. 2” can be completed. Thereafter, as shown in FIG. 5(B), the die plates 18 of the press machine 10 can respectively lowered, so that the die units 28 named as “No. 2” can respectively be clamped by the upper die clamps 24 and the lower die clamps 26. Thus, the press machine 10 can be continued, to work in a following process.

As described above, due to the die unit storage devices 30, carrying-in or discharging of the die units 28 can be performed from two directions in respective tiers of the press machine 10. Therefore, for example, the die units 28 can be discharged from the press machine 10 in a direction. At the same time, the new die units 28 that are selected by rotation of the die unit storage device 30 can be carried in the press machine 10 in another direction. Thus, in the press machine 10, various types of replacement die units 28 can be selected and replaced in a short time.

As described above, a best mode for carrying out the present invention has been described with reference to the drawings. However, the present embodiment can be easily changed or modified without departing from the scope of the present invention.

For example, the press machine 10 may be a normal type of press machine and not the multi-tiered press machine. Naturally, in this case, each of the die unit storage devices 30 may have a single turn table 34. In addition, one of the die unit storage devices 30 can be omitted. In such a case, in order to perform the die unit replacing operation, the die units 28 may first be discharged from the press machine 10 to the single die unit storage device 30. Thereafter, the die units 28 for replacement may be selected by rotation of the die unit storage device 30. Subsequently, the selected die units 28 may be carried in the press machine 10. Even in such a modified form, work efficiency of the die unit replacing operation can be improved compared with the conventional art.

Further, the die units 28 of the press machine 10 are exemplified in this description. However, the die units 28 may be die units for injection molding of resinous materials and not for press working of metal sheets or other such members.

### DESCRIPTION OF SYMBOLS

10 press machine
28 die unit
30 die unit storage device
T transferring mechanism

1. A press machine die unit replacing device for replacing die units in a press machine, comprising:
a die unit storage device controllably rotatably disposed on a position adjacent to a press machine and having various types of replacement die units that are placed thereon, and
a transferring mechanism that is capable of transferring the die units between the die unit storage device and the press machine,
wherein the die units selected by controllable rotation of the die unit storage device are capable of being carried in or discharged from the press machine via the transferring mechanism.

2. The press machine die unit replacing device as defined in claim 1, wherein two die unit storage devices are disposed adjacent to the press machine, and wherein the die units are capable of being carried in the press machine from the respective die unit storage devices via respective transferring mechanisms and capable of being discharged from the press machine via the transferring mechanisms.

3. The press machine die unit replacing device as defined in claim 1, wherein the press machine comprises a multi-tiered press machine in which a plurality of die units are arranged in series in a die closing and opening direction of each of the die units, and wherein the die unit storage device and the transferring mechanisms are positioned so as to correspond to respective tiers of the press machine.
